(19) United States
(12) Patent Application Publication
(10) Pub. No.: US 2021/0258700 A1
(43) Pub. Date: Aug. 19, 2021

(54) OPTICAL MICROPHONE

(71) Applicant: AAC Acoustic Technologies (Shenzhen) Co., Ltd., Shenzhen (CN)

(72) Inventor: Yannick Kervran, HK (FR)

(21) Appl. No.: 16/792,318

(22) Filed: Feb. 17, 2020

(51) Int. Cl. H04R 23/00; G02B 26/08; G02B 27/42

(52) U.S. Cl. CPC H04R 23/008; H04R 2201/003; G02B 27/4238; G02B 26/0825

(57) ABSTRACT

Provided is an optical microphone, including: an inner cavity and a sound inlet that allows the communication between the inner cavity and outside; an optoelectronic module including a light generator module and a light detector module; a MEMS module adjacent to the sound inlet and including a grating and a flexible diaphragm; and an ASIC module. The sound inlet is arranged in a shell wall of the shell. The optoelectronic module is arranged on another shell wall of the shell opposite to the sound inlet. A part of light emitted by the light generator module is diffracted by the grating, is incident on the flexible diaphragm and then is reflected to the light detector module by the flexible diaphragm, and another part of the light emitted by the light generator module is reflected to the light detector module by the reflective layer of the grating.

### TECHNICAL FIELD

The present disclosure relates to the technical field of microphones, and in particular, to an optical microphone.

### BACKGROUND

For traditional microphones based on capacitive principle, a diaphragm vibrates due to an incident sound wave, the distance between the two plates of the capacitor structure is changed, and a voltage change is generated, thereby realizing an acoustic-electric conversion.

As a different type of microphone, an optical microphone generally includes an optoelectronic module, an application specific integrated circuit (ASIC) module, and a micro-electro-mechanical system (MEMS) module. The optical module emits light towards the MEMS module and detects the light reflected by the MEMS module. When receiving the sound wave, the diaphragm of the MEMS module vibrates and the intensity and the phase of the light reflected back to the optoelectronic module is modified. The optoelectronic module converts a signal corresponding to the intensity and phase of the reflected light into an electrical signal, which is then transmitted to the ASIC module, to achieve the conversion from an acoustic signal to an optical signal and then to an electrical signal.

With increasing requirements on consumer experiences, it is necessary to propose an optical microphone with better sound transducing performances.

### SUMMARY

The present disclosure provides an optical microphone, including: a shell including an inner cavity and a sound inlet that allows the communication between the inner cavity and outside; an optoelectronic module arranged in the inner cavity and including a light generator module and light detector module; a MEMS module arranged in the inner cavity, adjacent to the sound inlet and including a grating and a flexible diaphragm; and an ASIC module arranged in the inner cavity and electrically connected to the optoelectronic module and the MEMS module. The flexible diaphragm is adjacent to the sound inlet and the grating is spaced from the flexible diaphragm in the direction of an incident sound wave. Each of the flexible diaphragm and the grating is provided with a reflective layer on the side facing towards the optoelectronic module. The sound inlet is arranged in a first shell wall of the shell. The optoelectronic module is arranged on a second shell wall of the shell opposite to the sound inlet. A part of the light emitted by the light generator module is diffracted by the grating, then is incident on the flexible diaphragm and then is reflected back to the light detector module by the flexible diaphragm, and another part of the light emitted by the light generator module is reflected back to the light detector module by the reflective layer of the grating.

In an implementation, the MEMS module further includes a lens spaced from the grating and arranged at the side of the grating facing towards the optoelectronic module. The light emitted by the light generator module is perpendicularly incident on the lens, then is refracted by the lens, and then is obliquely incident on the grating. And the light reflected from the grating or the diaphragm is obliquely incident on the lens, then is refracted by the lens, and then is perpendicularly incident on the light detector module.

In an implementation, the MEMS module further includes a support arm supporting the flexible diaphragm and fixed to the first shell wall; the grating is spaced from the flexible diaphragm by a support part and arranged at the side of the flexible diaphragm facing the optoelectronic module; and the flexible diaphragm divides the inner cavity into a front cavity and a rear cavity in the incident direction of the sound wave.

In an implementation, the flexible diaphragm is further provided with a ventilation hole allowing the communication between the front cavity and the rear cavity.

In an implementation, the grating includes a plurality of gaps that are spaced from and parallel with each other.

In an implementation, the grating is made of a lens, and the lens is provided with at least one layer of diffraction surface.

In an implementation, the ASIC module is arranged on the second shell wall.

In an implementation, the light generator module and the light detector module are arranged on different dies.

In an implementation, the light detector module includes a plurality of light detectors.

In an implementation, the light generator module and the light detector module are arranged on a same die.

In combination with the technical solutions described above, the present disclosure can provide following beneficial effects:

When the optical microphone is in use, sound waves enter the shell via the sound inlet and actuate the vibrations of the flexible diaphragm, and consequently the actuation of a distance change between the flexible diaphragm and the grating. A part of the light emitted by the light generator module is diffracted by the grating and then reaches the flexible diaphragm and then is reflected back to the light detector module by the flexible diaphragm, and another part is directly reflected back to the light detector module by the reflective layer of the grating. As a result, these two parts of the light have an amplitude difference and a phase difference when they reach the light detector module, and the amplitude difference and the phase difference are related to the distance between the flexible diaphragm and the grating. Therefore, the MEMS module, the optoelectronic module and the ASIC module can achieve conversion of an acoustic signal to an optical signal and then to an electrical signal.

For the optical microphone of the present disclosure, the optoelectronic module is arranged in the back cavity, on the opposite side of the MEMS module which covers the sound inlet, and the flexible diaphragm of the MEMS module faces the sound inlet, the grating of the MEMS module faces the optoelectronic module inside the back cavity, the front cavity is empty and the sound inlet has a large caliber, thereby improving the performance. Moreover, for the optical microphone of the present disclosure, the flexible diaphragm of the MEMS module is arranged adjacent to the sound inlet such that the front cavity has a smaller volume and the rear cavity has a larger volume, in order also for further improving the performance. In a word, the optical microphone has good sound transducing performances.

Other features and advantages of the embodiments of the present disclosure will be described in the following description, and part of them will be apparent from the description or be understood by implementing the embodiments of the present disclosure. The purposes and other advantages of the embodiments of the present disclosure are achieved and obtained in the structures specifically described in the description and the accompanying drawings.

### BRIEF DESCRIPTION OF DRAWINGS

FIG. 1 illustrates a first structure of an optical microphone according to an embodiment of the present disclosure;

FIG. 2 illustrates a second structure of an optical microphone according to an embodiment of the present disclosure;

FIG. 3 illustrates a third structure of an optical microphone according to an embodiment of the present disclosure;

FIG. 4 illustrates a fourth structure of an optical microphone according to an embodiment of the present disclosure; and

FIG. 5 illustrates the grating and the support substrate of an optical microphone according to an embodiment of the present disclosure.

### REFERENCE NUMERALS

1-shell;
11-sound inlet;
12-first shell wall;
13-second shell wall;
14-side shell wall;
2-optoelectronic module;
21-light generator module;
22-light detector module;
3-micro-electro-mechanical system module;
31-diaphragm part;
311-ventilation hole;
312-flexible diaphragm;
313-support arm;
32-grating;
321-diffraction surface;
33-support part;
34-lens;
35-support substrate;
351-openning;
4-application specific integrated circuit module; and
X-incident direction of sound wave.

The drawings herein are incorporated into and constitute a part of the present specification, illustrate embodiments of the present disclosure and explain principles of the present disclosure together with the specification.

### DESCRIPTION OF EMBODIMENTS

For better illustrating technical solutions of the present disclosure, embodiments of the present disclosure will be described in detail as follows with reference to the accompanying drawings.

It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character form an “or” relationship.

It should be understood that, the terms such as “upper”, “lower”, “left”, “right” and the like are used to indicate positions shown in the drawing, instead of being construed as limitations of the embodiment of the present disclosure. In addition, when an element is described as being “on” or “under” another element in the context, it should be understood that the element can be directly or via an intermediate element located “on” or “under” another element.

The specific embodiments will be described in the following with reference to structures of the optical microphones according to the embodiments of the present disclosure.

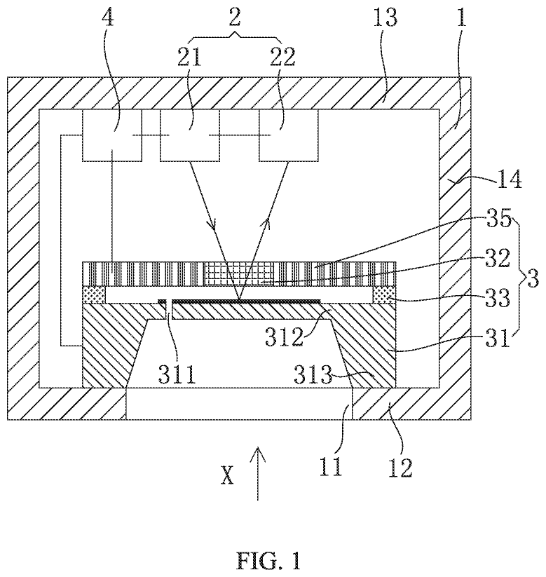

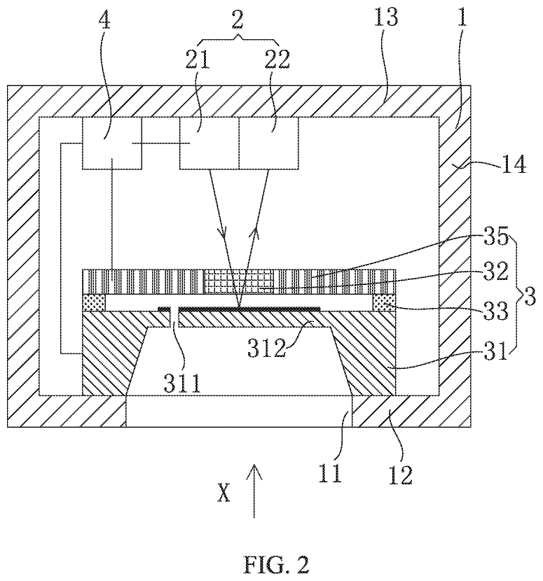

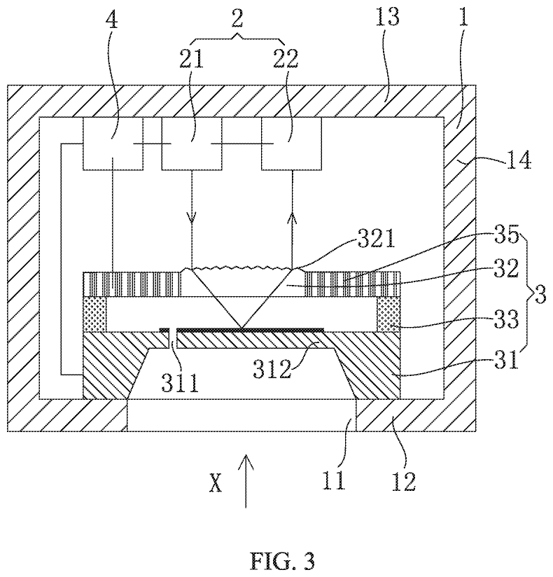

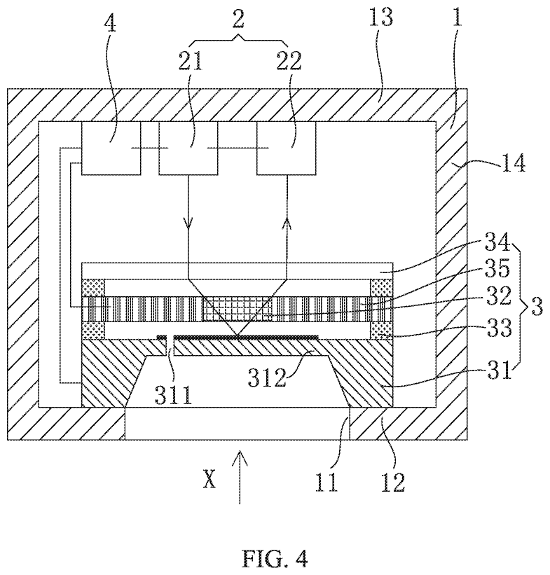

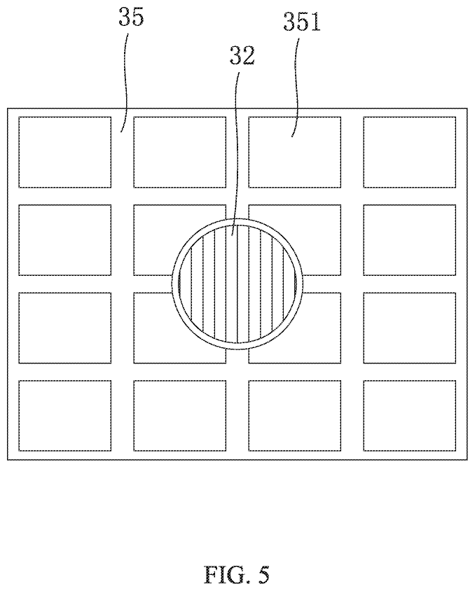

FIG. 1 illustrates a first structure of an optical microphone according to an embodiment of the present disclosure; FIG. 2 illustrates a second structure of an optical microphone according to an embodiment of the present disclosure; FIG. 3 illustrates a third structure of an optical microphone according to an embodiment of the present disclosure; FIG. 4 illustrates a fourth structure of an optical microphone according to an embodiment of the present disclosure; and FIG. 5 illustrates the grating and the support substrate of an optical microphone according to an embodiment of the present disclosure.

As shown in FIG. 1 to FIG. 5, an embodiment of the present disclosure provides an optical microphone. The optical microphone includes a shell 1, an optoelectronic module 2, a MEMS module 3, and an ASIC module 4. The shell 1 includes an inner cavity, and a sound inlet 11 allowing the communication between the inner cavity and outside. The optoelectronic module 2 is arranged in the internal cavity and includes a light generator module 21 and a light detector module 22. The MEMS module 3 is arranged in the internal cavity and covers the sound inlet 11, and includes a grating 32 and a diaphragm part 31. The ASIC module 4 is arranged in the internal cavity and electrically connected to the optoelectronic module 2 and the MEMS module 3.

The shell 1 includes a first shell wall 12 provided with the sound inlet 11, a second shell wall 13 provided with the optoelectronic module 2 and side shell walls 14 connecting the first shell wall 12 and the second shell wall 13. And the side shell walls 14 could be manufactured as a part of the first shell wall 12, a part of the second shell wall 13 or just an individual part.

The diaphragm part 31 includes a flexible diaphragm 312, and a support arm 313 supporting the flexible diaphragm 312 and fixed to the first shell wall 12. The grating 32 is spaced from flexible diaphragm 312 by a support part 33, and is arranged at a side of the flexible diaphragm 312 facing the optoelectronic module 2. The flexible diaphragm 312 divides the inner cavity into a front cavity and a rear cavity in the direction X of the incident sound wave. The diaphragm part 31 covers the sound inlet 11. Each of the flexible diaphragm 312 and the grating 32 is provided with a reflective layer on the side facing towards the optoelectronic module 2. A part of light emitted by the light generator module 21 is diffracted by the grating 32, then is incident on the flexible diaphragm 312 and then is reflected back to the light detector module 22 by the flexible diaphragm 312, and another part of the light is reflected back to the light detector module 22 by the reflective layer of the grating 32.

When the optical microphone is in use, sound waves enter the shell 1 via the sound inlet 11 and the flexible diaphragm 312 vibrates, in such a manner that the distance between the flexible diaphragm 312 and the grating 32 is changed. A part of the light emitted by the light generator module 21 is diffracted by the grating 32, then is incident on the flexible diaphragm 312 and then is reflected back to the light detector module 22 by the flexible diaphragm 312, and another part is directly reflected back to the light detector module 22 by the reflective layer of the grating 32. As a result, these two parts of the light have an amplitude difference and a phase difference when they reach the light detector module 22, and the amplitude difference and the phase difference are related to the distance between the flexible diaphragm 312 and the grating 32. Therefore, the MEMS module 3, the optoelectronic module 2 and the ASIC module 4 can achieve conversion from an acoustic signal to an optical signal and then to an electrical signal.

In the optical microphone according to this embodiment of the present disclosure, the optoelectronic module 2 is arranged in the back cavity, on the opposite side of the MEMS module 3 which covers the sound inlet 11, and the flexible diaphragm 312 of the MEMS module 3 faces the sound inlet 11, the grating 32 of the MEMS module 3 faces the optoelectronic module 2 inside the back cavity, the front cavity is empty and the sound inlet 11 has a large caliber, thereby improving performances. Moreover, with the optical microphone according to this embodiment of the present disclosure, the flexible diaphragm 312 of the MEMS module 3 is adjacent to the sound inlet 11 such that the front cavity has a smaller volume and the rear cavity has a larger volume, thereby facilitating further performances improvement.

In an implementation, the MEMS module 3 further includes a lens 34 that are spaced from the grating 32 and arranged at a side of the grating 32 facing towards the optoelectronic module 2. The light emitted by the light generator module 21 is perpendicularly incident on the lens 34, then is refracted by the lens 34, and then is obliquely incident on the grating 32. And then a part of light is diffracted by the grating 32, then is incident on the flexible diaphragm 312 and then is reflected back to the lens 34 by the flexible diaphragm 312, and another part of the light is reflected back to the lens 34 by the grating 32. And the light reflected from the grating or from the diaphragm is obliquely incident on the lens 34, then is refracted by the lens 34, and then is perpendicularly incident on the light detector module 22.

Specifically, as shown in FIG. 4, a lens 34 is provided at a side of the grating 32 facing towards the optoelectronic module 2, and the path of the light emitted by the light generator module 21 can be changed by a refraction function of the lens 34. In this way, the dies for light generator module 21 can be mounted flat on the shell wall of the shell 1 without tilting, so that the light emitted by the light generator module 21 has an incident angle smaller than 90° with regard to the grating 32. Similarly, with the lens 34, the dies for the light detector module 22 can also be mounted flat on the shell wall of the shell 1. So that, the light from the light generator module 21 can be reflected to the light detector module 22 even when the dies for light detector module 22 is far from the dies for the light generator module 21 without tilting the dies. Therefore, such a structure can facilitate an arrangement of the light generator module 21 and light detector module 22 during the manufacturing assembly.

In an implementation, the flexible diaphragm 312 is further provided with a ventilation hole 311 allowing the communication between the front cavity and the rear cavity.

Specifically, as shown in FIG. 1, the ventilation hole 311 allow the communication between the front cavity and the rear cavity, so that the pressure in the front cavity and the rear cavity can be balanced, thereby facilitating the vibration of the flexible diaphragm 312 under the action of the sound waves.

In an implementation, the grating 32 includes a plurality of gaps that are spaced from and parallel with each other.

The grating 32 may be provided with a reflective plane. For example, a substrate of the grating 32 can be made of silicon, and a metal film is deposited on the surface of the grating facing the optoelectronics module to form the reflective plane. Such metal can be, but are not limited to, gold, aluminum, silver or copper, using the adequate fabrication process technique.

In an implementation, the grating 32 is made of a lens, and the lens is provided with at least one layer of diffraction surface 321.

Specifically, as shown in FIG. 3, the lens can be made of glass, and the diffraction surface 321 is formed on the glass by realizing a regular pattern of non-flat surface shape such as steps with one direction much longer than the other to create a line shape, and light diffraction is achieved by the structure of the diffraction surface 321.

In an implementation, as shown in FIG. 5, the grating 32 is surrounded and supported by a support substrate 35. The support substrate contains opennings 351 to let the air flow easily and the shape of the opennings 351 is not limited. The support substrate 35 is supported by the support part 33.

In an implementation, the ASIC module 4 is further electrically connected to the flexible diaphragm 312 and the grating 32, so as to generate an electrostatic force between the flexible diaphragm 312 and the grating 32.

Specifically, as shown in FIG. 1, the ASIC module 4 is electrically connected to the flexible diaphragm 312 and the grating 32. An electrostatic force can be generated by applying a voltage between the flexible diaphragm 312 and the grating 32 using the ASIC module 4, so that an “electrostatic spring” can be generated between the flexible diaphragm 312 and the grating 32. When the flexible diaphragm 312 vibrates, the “electrostatic spring” can be controlled either to increase or decrease the vibration amplitude of the flexible diaphragm 312.

In an implementation, the shell 1 is made of PCB stacks. Circuits are formed in the PCB stacks, and ASIC module 4 is electrically connected to the flexible diaphragm 312 and the grating 32 via the circuits. And, ASIC module 4 can be arranged on the first shell wall 12, the second shell wall 13 or the side shell wall 14.

In an implementation, the light generator module 21 and the light detector module 22 are provided on different dies.

Specifically, as shown in FIG. 1, the light generator module 21 may be a laser diode, and the light detector module 22 may be a photodiode. The laser diode and the photodiode are provided on different dies.

In an implementation, the light detector module 22 may include a plurality of light detectors.

In an implementation, the light generator module 21 and the light detector module 22 may also be provided on a same die.

Specifically, as shown in FIG. 2, only one photodiode is provided and can be integrated with the laser on the same die. This can simplify an overall structure of the optoelectronic module 2, while facilitating installation of the optoelectronic module 2.

The above-described embodiments are merely preferred embodiments of the present disclosure and are not intended to limit the present disclosure. Any modifications, equivalent substitutions and improvements made within the principle of the present disclosure shall fall into the protection scope of the present disclosure.

What is claimed is:

1. An optical microphone, comprising:
a shell comprising an inner cavity and a sound inlet that allows the communication between the inner cavity and outside;
an optoelectronic module arranged in the inner cavity and comprising a light generator module and at least one light detector module;
a MEMS module arranged in the inner cavity, adjacent to the sound inlet and comprising a grating and a flexible diaphragm; and
an ASIC module arranged in the inner cavity and electrically connected to the optoelectronic module and the MEMS module,
wherein the flexible diaphragm is adjacent to the sound inlet and the grating is spaced from the flexible diaphragm in the direction of an incident sound wave, and each of the flexible diaphragm and the grating is provided with a reflective layer at the side facing towards the optoelectronic module;
the sound inlet is arranged in a first shell wall of the shell;
the optoelectronic module is arranged on a second shell wall of the shell opposite to the sound inlet;
a part of the light emitted by the light generator module is diffracted by the grating, then is incident on the flexible diaphragm and then is reflected back to the light detector module by the flexible diaphragm, and another part of the light emitted by the light generator module is reflected back to the light detector module by the reflective layer of the grating.

2. The optical microphone as described in claim 1, wherein the MEMS module further comprises a lens spaced from the grating and arranged at the side of the grating facing towards the optoelectronic module;
when the light emitted by the light generator module is perpendicularly incident on the lens, it will be refracted by the lens and be obliquely incident on the grating;
when the light reflected from the grating or diaphragm is obliquely incident on the lens, it will be refracted by the lens and perpendicularly incident on the light detector module.

3. The optical microphone as described in claim 1, wherein the MEMS module further comprises a support arm supporting the flexible diaphragm and fixed to the first shell wall;
the grating is spaced from the flexible diaphragm by a support part and arranged at the side of the flexible diaphragm facing the optoelectronic module; and the flexible diaphragm divides the inner cavity into a front cavity and a rear cavity in the incident direction of the sound wave.

4. The optical microphone as described in claim 3, wherein the flexible diaphragm is further provided with a ventilation hole allowing the communication between the front cavity and the rear cavity.

5. The optical microphone as described in claim 1, wherein the grating comprises a plurality of gaps that are spaced from and parallel with each other.

6. The optical microphone as described in claim 1, wherein the grating is made of a lens, and the lens is provided with at least one layer of diffraction surface.

7. The optical microphone as described in claim 1, wherein the ASIC module is arranged on the second shell wall.

8. The optical microphone as described in claim 1, wherein the light generator module and the light detector module are arranged on different dies.

9. The optical microphone as described in claim 8, wherein the light detector module comprises a plurality of light detectors.

10. The optical microphone as described in claim 1, wherein the light generator module and the light detector module are arranged on a same die.
